(19) United States
(12) Patent Application Publication
(10) Pub. No.: US 2016/0107724 A1
(43) Pub. Date: Apr. 21, 2016

(54) BICYCLE DERAILLEUR

(71) Applicant: Shuei-Sheng Bao, New Taipei City (TW)

(72) Inventor: Shuei-Sheng Bao, New Taipei City (TW)

(21) Appl. No.: 14/517,928

(22) Filed: Oct. 20, 2014

(51) Int. Cl. B62M 9/1242; B62M 9/125; B62M 9/124

(52) U.S. Cl. CPC B62M 9/1242; B62M 9/124; B62M 9/125

(57) ABSTRACT

A bicycle derailleur includes: a passive first derailleur, installed on a fasten plate and a rear shaft of a bicycle and provided with a chain pulling arm; and characterized in that: an active second derailleur is provided, a lower fasten part thereof and a lower fasten part of the passive first derailleur and a horizontal frame rod of the bicycle are provided with a guide plate, the upper portion of the guide plate is disposed at the front end of the chain, the middle portion thereof is disposed at the lower fasten part of the active second derailleur, and the lower portion thereof is disposed on a fasten shaft of the passive first derailleur. Accordingly, the active second derailleur is enabled to allow the guide plate to synchronously drive the passive first derailleur and the shifting is able to be achieved through the chain being normally or reversely operated.

### BACKGROUND OF THE INVENTION

### 1. Field of the Invention

The present invention relates to a derailleur, especially to a bicycle derailleur capable of allowing an active second derailleur to be inclined towards inward or moved towards outward, allowing a guide plate fastened with the active second derailleur to synchronously drive an upper shaft at the upper portion thereof and an elongated slide groove at the lower portion thereof and allowing a passive first derailleur to be moved towards inward or outward.

### SUMMARY OF THE INVENTION

For improving the disadvantages of prior art, the primary objective of the present invention is to provide a bicycle derailleur capable of allowing an active second derailleur to be inclined towards inward or moved towards outward, allowing a guide plate fastened with the active second derailleur to synchronously drive an upper shaft at the upper portion thereof and an elongated slide groove at the lower portion thereof and allowing a passive first derailleur to be moved towards inward or outward so as to overcome the shortages existed in prior art.

One technical solution of the present invention is to provide a bicycle derailleur, the bicycle is installed with a chainwheel and a horizontal frame rod and a rear fasten plate and a rear wheel having a freewheel and a rear shaft, wherein a chain sleeved on the chainwheel and the freewheel allows the rear wheel to be forwardly rotated for normally operating the chain and allows the rear wheel to be stopped for reversely operating the chain thereby providing the bidirectional shifting, the bicycle derailleur includes: a passive first derailleur installed on the fasten plate and the rear shaft of the bicycle, the passive first derailleur is able to be moveably inclined towards inward and the top and the bottom ends are respectively formed with an upper fasten part and a lower fasten part, the inner side defined at the top end of the upper fasten part is provided with a buckle plate having a buckle recess, the buckle plate is correspondingly installed on the rear fasten plate of the horizontal frame rod of the bicycle and the rear shaft having a nut served as a fasten member, the buckle plate is formed with a positioning hole, the positioning hole is sleeved and fastened on the fasten plate of the bicycle by utilizing a screw served as a fasten member, the lower fasten part is formed with a lower shaft hole, and the inner side thereof is downwardly and transversally extended with a moveable chain pulling arm, the top and the bottom ends of the chain pulling arm are respectively formed with upper guide teeth and lower guide teeth for allowing the chain of the bicycle to be normally operated for being guided onto the freewheel of the rear wheel, the upper guide teeth adjacent to the chain pulling arm are provided with a fasten shaft which is outwardly extended, the fasten shaft is corresponding to the lower shaft hole of the lower fasten part of the passive first derailleur, the fasten shaft is sleeved with a torsion spring allowing the chain pulling arm to be turned and folded; and characterized in that:

an active second derailleur is provided and the top end of the passive first derailleur is substantially in parallel with the active second derailleur; the active second derailleur is able to be movably inclined towards inward, and the bottom end defined at the inner side and the top end defined at the outer side are respectively provided with a pull string seat allowing a pull string to be abutted against and a fasten seat allowing the distal end of the pull string to be fastened, the top and the bottom ends of the active second derailleur are respectively formed with an upper fasten part and a lower fasten part, the upper fasten part of the active second derailleur is formed with an upper shaft hole and fastened on the rear shaft of the bicycle and located at the outer side of the buckle plate of the passive first derailleur, and a nut served as a fasten member is provided for fastening, the lower fasten part of the active second derailleur is formed with a lower shaft hole; the outer periphery of the torsion spring of the fasten shaft of the chain pulling arm of the passive first derailleur is sleeved with two corresponding inner springs; the lower shaft hole of the active second derailleur is provided a fasten member; the lower fasten part of the active second derailleur and the lower fasten part of the passive first derailleur and the horizontal frame rod of the bicycle are provided with a guide plate, the upper, the middle and the lower portions of the guide plate are respectively formed with an upper shaft, a fasten hole and an elongated slide groove, wherein the upper shaft is formed at top end defined in the upper portion of the guide plate and the outer side defined at the front end of the chain sleeved with the freewheel of the rear wheel of the bicycle for allowing the chain to be reversely operated for being guided onto the freewheel of the rear wheel, the fasten hole of the guide plate is corresponding to the inner side of the lower shaft hole of the lower fasten part of the active second derailleur, and is fastened by fasten member provided in the lower shaft hole, the elongated slide groove of the guide plate is sleeved at the center defined at the outer periphery of the torsion spring sleeved with the fasten shaft at the top end of the chain pulling arm of the passive first derailleur, and the two inner springs sleeved at the outer periphery of the torsion spring are clamped at two sides defined at the rear portion of the guide plate where the elongated slide groove is formed.

Furthermore, according to the present invention, the bottom end of the upper shaft of the guide plate is further formed with a recess part which is vertically latched on the horizontal frame rod of the bicycle.

Preferably, according to the present invention, the upper shaft of the guide plate is provided with a rolling tube.

Preferably, according to the present invention, the fasten member provided in the lower shaft hole of the active second derailleur is a screw and a nut.

Comparing with prior art, the present invention is provided with following novel features: the bottom end defined at the inner side and the top end defined at the outer side of the active second derailleur are respectively provided with the pull string seat allowing the pull string to be abutted against and the fasten seat allowing the distal end of the pull string to be fastened for the purpose of pulling or releasing, so the active second derailleur is enabled to be inclined towards inward or moved towards outward, and the guide plate fastened with the active second derailleur is able to synchronously drive the upper shaft at the upper portion thereof and the elongated slide groove at the lower portion thereof, and the passive first derailleur is able to be moved towards inward or outward, so when the rear wheel having the freewheel of the bicycle is forwardly rotated, the chain sleeved on the freewheel is able to be normally operated and the shifting is able to be achieved through the passive first derailleur being inclined and moved, when the rotation of the rear wheel having the freewheel of the bicycle is stopped, the chain sleeved on the freewheel is able to be reversely operated and the shifting is able to be achieved through the upper shaft of the guide plate of the lower fasten part of the active second derailleur and the passive first derailleur being inclined and moved; accordingly, the operation efficiency and convenience can be greatly enhanced, and the present invention is novel and more practical in use comparing to prior art.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective exploded view according to the present invention;

FIG. 2 is a perspective view showing the assembly according to the present invention;

FIG. 3 is a cross sectional view showing the assembly according to the present invention;

FIG. 4 is a schematic view illustrating the rear wheel being stopped and the chain being reversely operated for shifting according to one embodiment of the present invention; and

FIG. 5 is a schematic view illustrating the rear wheel and the freewheel being forwardly rotated and the chain being normally operated for shifting according to one embodiment of the present invention.

### DETAILED DESCRIPTION OF THE PREFERRED EMBODIMENT

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

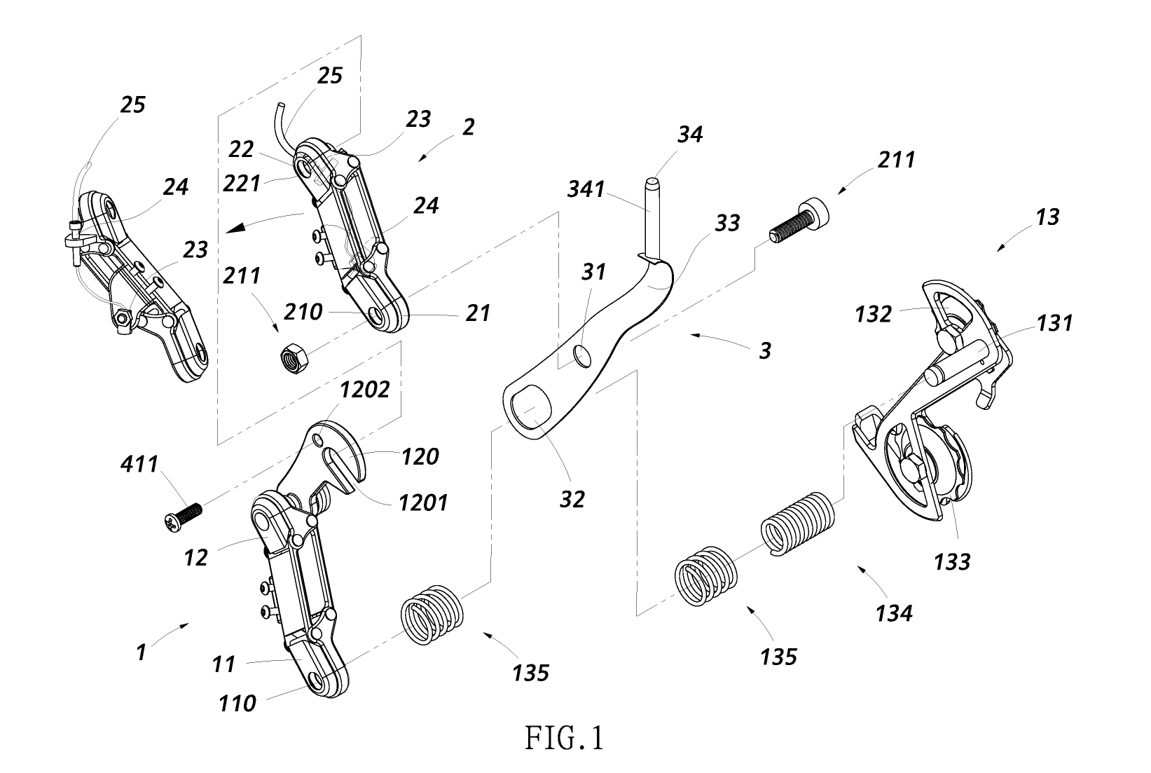

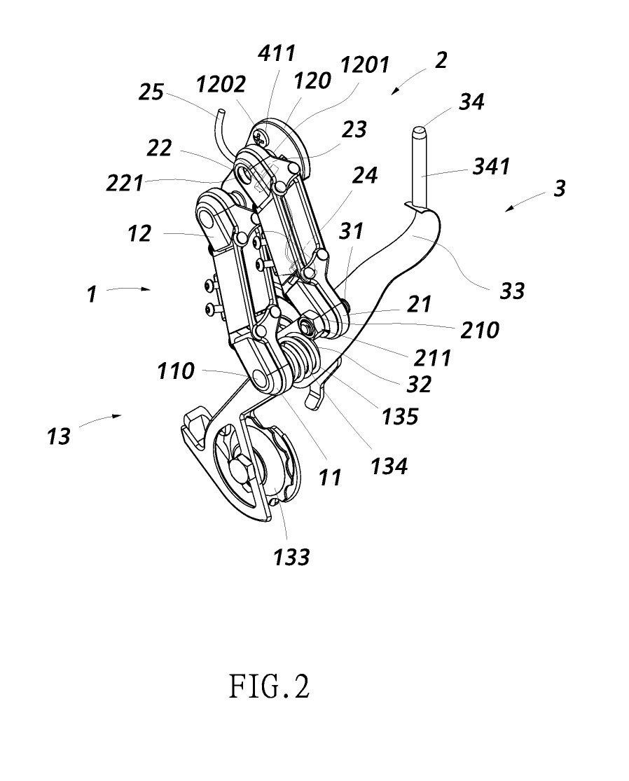

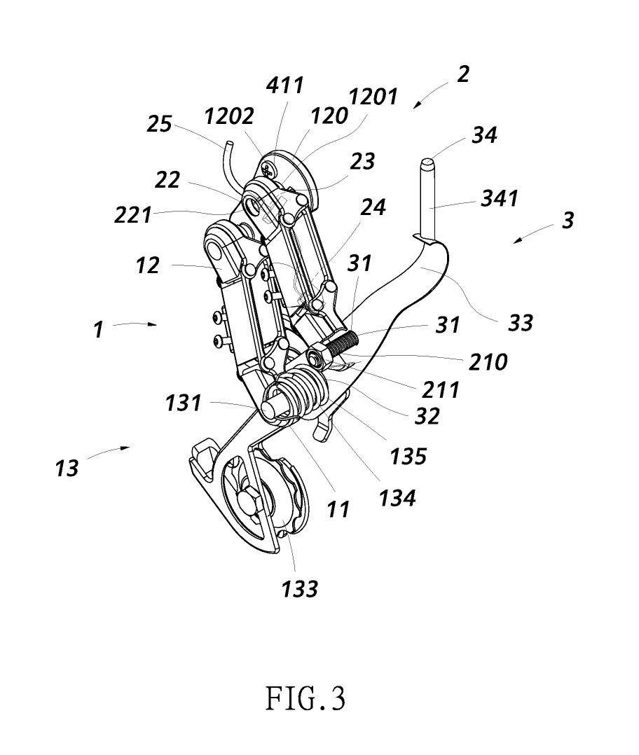

Referring from FIG. 1 to FIG. 3, wherein FIG. 1 is a perspective exploded view according to the present invention; FIG. 2 is a perspective view showing the assembly according to the present invention; and FIG. 3 is a cross sectional view showing the assembly according to the present invention. The present invention provides a bicycle derailleur, which is installed on a bicycle 200 having a chainwheel 7 and a horizontal frame rod 4 and a rear fasten plate 41 and a rear wheel 5 having a freewheel 51 and a rear shaft 52, wherein a chain 6 sleeved on the chainwheel 7 and the freewheel 51 allows the rear wheel 5 to be forwardly rotated for normally operating the chain 6 and allows the rear wheel 5 to be stopped for reversely operating the chain 6 thereby providing the bidirectional shifting. According to one embodiment of the present invention, a passive first derailleur 1 is provided and installed on the fasten plate 41 and the rear shaft 52 of the bicycle 200, the passive first derailleur 1 is able to be moveably inclined towards inward and formed with an upper fasten part 12 and a lower fasten part 11 respectively at the top and the bottom ends, the inner side defined at the top end of the upper fasten part 12 is provided with a buckle plate 120 having a buckle recess 1201, the buckle plate 120 is correspondingly installed on the rear fasten plate 41 of the horizontal frame rod 4 of the bicycle 200 and the rear shaft 52 having a nut served as a fasten member 521, the buckle plate 120 is formed with a positioning hole 1202, the positioning hole 1202 is sleeved and fastened on the fasten plate 41 of the bicycle 200 by utilizing a screw served as a fasten member 411, the lower fasten part 11 is formed with a lower shaft hole 110, and the inner side thereof is downwardly and transversally extended with a moveable chain pulling arm 13, the top and the bottom ends of the chain pulling arm 13 are respectively formed with upper guide teeth 132 and lower guide teeth 133 for allowing the chain 6 of the bicycle 200 to be normally operated for being guided onto the freewheel 51 of the rear wheel 5, the upper guide teeth 132 adjacent to the chain pulling arm 13 are provided with a fasten shaft 131 which is outwardly extended, the fasten shaft 131 is corresponding to the lower shaft hole 110 of the lower fasten part 11 of the passive first derailleur 1, the fasten shaft 131 is sleeved with a torsion spring 134 allowing the chain pulling arm 13 to be turned and folded; and characterized in that:

An active second derailleur 2 is provided and the top end of the passive first derailleur 1 is substantially in parallel with the active second derailleur 2; the active second derailleur 2 is able to be movably inclined towards inward, and the bottom end defined at the inner side and the top end defined at the outer side are respectively provided with a pull string seat 23 allowing a pull string 25 to be abutted against and a fasten seat 24 allowing the distal end of the pull string 25 to be fastened, the top and the bottom ends of the active second derailleur 2 are respectively formed with an upper fasten part 22 and a lower fasten part 21, the upper fasten part 22 of the active second derailleur 2 is formed with an upper shaft hole 221 and fastened on the rear shaft 52 of the bicycle 200 and located at the outer side of the buckle plate 120 of the passive first derailleur 1, and a nut served as a fasten member 521 is provided for fastening, the lower fasten part 21 of the active second derailleur 2 is formed with a lower shaft hole 210; the outer periphery of the torsion spring 134 of the fasten shaft 131 of the chain pulling arm 13 of the passive first derailleur 1 is sleeved with two corresponding inner springs 135; the lower shaft hole 210 of the active second derailleur 2 is provided with a screw and a nut served as a fasten member 31; the lower fasten part 21 of the active second derailleur 2 and the lower fasten part 11 of the passive first derailleur 1 and the horizontal frame rod 4 of the bicycle 200 are provided with a guide plate 3, the upper, the middle and the lower portions of the guide plate 3 are respectively formed with an upper shaft 34, a fasten hole 31 and an elongated slide groove 32, wherein the upper shaft 34 is formed at top end defined in the upper portion of the guide plate 3 and the outer side defined at the front end of the chain 6 sleeved with the freewheel 51 of the rear wheel 5 of the bicycle 200 for allowing the chain 6 to be reversely operated for being guided onto the freewheel 51 of the rear wheel 5, and the bottom end thereof is further formed with a recess part 33, the recess part 33 is vertically latched on the horizontal frame rod 4 of the bicycle 200; according to this embodiment, the upper shaft 34 of the guide plate 3 is provided with a rolling tube 341; the fasten hole 31 of the guide plate 3 is corresponding to the inner side of the lower shaft hole 210 of the lower fasten part 21 of the active second derailleur 2, and is fastened by a screw and a nut provided in the lower shaft hole 210 and served as a fasten member 211, the elongated slide groove 32 of the guide plate 3 is sleeved at the center defined at the outer periphery of the torsion spring 134 sleeved with the fasten shaft 131 at the top end of the chain pulling arm 13 of the passive first derailleur 1, and allows the fasten shaft 131 sleeved with the torsion spring 134 of the passive first derailleur 1 to be upwardly/downwardly moved in the elongated slide groove 32 of the guide plate 3, and the two inner springs 135 sleeved at the outer periphery of the torsion spring 134 are clamped at two sides defined at the rear portion of the guide plate 3 where the elongated slide groove 32 is formed for providing a positioning effect after the upward/downward movement.

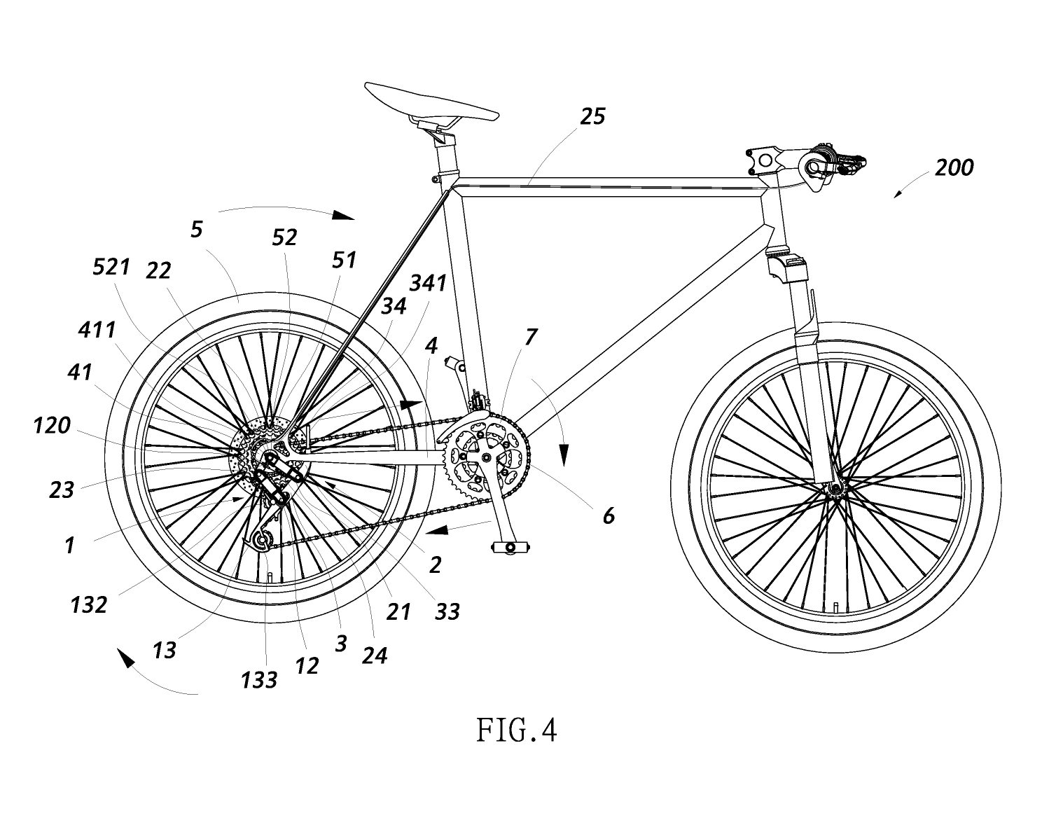

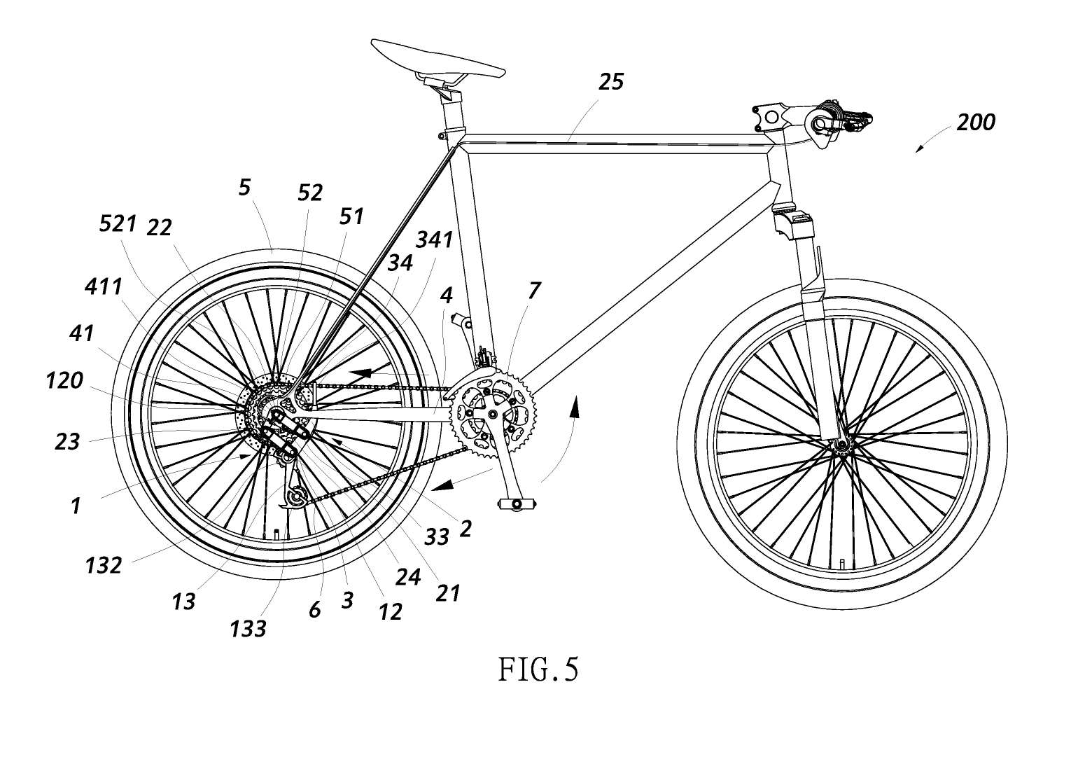

Referring to FIG. 4 and FIG. 5, wherein FIG. 4 is a schematic view illustrating the rear wheel being stopped and the chain being reversely operated for shifting according to one embodiment of the present invention and FIG. 5 is a schematic view illustrating the rear wheel and the freewheel being forwardly rotated and the chain being normally operated for shifting according to one embodiment of the present invention. The installing path of the chain 6 is from the bottom end of the lower guide teeth 133 of the chain pulling arm 13 of the first derailleur 1 then leaded towards rear then upwardly to the upper guide teeth 132, the front end thereof is upwardly leaded to the freewheel 51 and further leaded toward the front, when the rear wheel 5 of the bicycle 200 is stopped, for allowing the chain 6 to be selectively sleeved at the inner side or outer side of the freewheel 51 which is composed of a plurality of gears for the purpose of shifting, the pull string seat 23 allowing the pull string 25 to be abutted against and the fasten seat 24 allowing the distal end of the pull string 25 to be fastened which are both installed in the active second derailleur 2 are utilized for pulling or releasing, so the active second derailleur 2 is enabled to be inclined towards inward or moved towards outward and to synchronously drive the guide plate 3 to be moved towards inward and outward, when the pull string 25 is pulled, the upper shaft 34 at the top end of the guide plate 3 is able to push the chain 6 to be moved from the outer side to the inner side, in other words the chain 6 is moved to the front end of the freewheel 51 composed of plural gears having different dimensions, and the front end of the chain 6 is moved to a desired position for the purpose of shifting, at this moment the chain 6 is reversely operated so the chain 6 is sleeved at the relative rear end of the freewheel 51, and at the same moment the active second derailleur 2 is moved from the outer side to the inner side, the lower portion of the guide plate 3 is enabled to control the passive first derailleur 1 to be inclined towards inward, and the upper guide teeth 132 of the chain pulling arm 13 is enabled to guide the chain 6 at the rear end of the freewheel 51 to the same position defined at the front end of the freewheel 51, so the objective of reversely operating the chain 6 for shifting is achieved (as shown in FIG. 4); in addition, the active second derailleur 2 and the passive first derailleur 1 being moved towards outward does not require the pulling force provided by the pull string 25, so the pull string 25 is released and the elastic force provided by the torsion spring (not shown in figures) disposed inside the upper fasten parts 12, 22 of the active second derailleur 2 and the passive first derailleur 1 can be utilized for recovery; when the guide plate 3 is at the outmost side of the horizontal frame rod 4, the recessed part 33 thereof is mounted in the horizontal frame rod 4, so the location of the chain 6 is not affected by the upper shaft 34 (as shown from FIG. 1 to FIG. 4); when the freewheel 51 and the rear wheel 5 of the bicycle 200 are forwardly rotated and the chain 6 is normally operated, the shifting also utilizes the pull string 25 to enable the active second derailleur 2 to drive the guide plate 3 and the passive first derailleur 1, because the rear wheel 5 and the chain 6 are normally rotated and operated, the front end of the chain 6 guided onto the freewheel 51 is located in the upper guide teeth 132 of the chain pulling arm 13 of the passive first derailleur 1, when being driven by the passive first derailleur 1 for synchronous movement, the front end of the chain 6 is enabled to reach the desired shifting and guided to the correct location defined on the freewheel 51 composed of gears having different dimensions, at this moment, because the chain 6 is being normally operated, the chain 6 at the rear end of the freewheel 51 is pushed by the upper shaft 34 of the guide plate 3 for being at the same location, when the chainwheel 7 at the front portion of the bicycle 200 is normally rotated, the chain 6 is enabled to be normally operated and the shifting objective is achieved (as shown in FIG. 5), when the upper guide teeth 132 is desired to be moved from the inner side to the outer side, the pull string 25 does not required to be pulled, and the elastic force provided by the torsion spring (not shown in figures) disposed inside the upper fasten parts 12, 22 of the active second derailleur 2 and the passive first derailleur 1 can be utilized for recovery.

With the above-mentioned structure, the bottom end defined at the inner side and the top end defined at the outer side of the active second derailleur 2 are respectively provided with the pull string seat 23 allowing the pull string 25 to be abutted against and the fasten seat 24 allowing the distal end of the pull string 25 to be fastened for the purpose of pulling or releasing, so the active second derailleur 2 is enabled to be inclined towards inward or moved towards outward, and the guide plate 3 fastened with the active second derailleur 2 is able to synchronously drive the upper shaft 34 at the upper portion thereof and the elongated slide groove 32 at the lower portion thereof, and the passive first derailleur 1 is able to be moved towards inward or outward, so when the rear wheel 5 having the freewheel 51 of the bicycle 200 is forwardly rotated, the chain 6 sleeved on the freewheel 51 is able to be normally operated and the shifting is able to be achieved through the passive first derailleur 1 being inclined and moved, when the rotation of the rear wheel 5 having the freewheel 51 of the bicycle 200 is stopped, the chain 6 sleeved on the freewheel 51 is able to be reversely operated and the shifting is able to be achieved through the upper shaft 34 of the guide plate 3 of the lower fasten part 21 of the active second derailleur 2 and the passive first derailleur 1 being inclined and moved. Accordingly, the operation efficiency and convenience can be greatly enhanced, and the present invention is novel and more practical in use comparing to prior art.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A bicycle derailleur, being installed on a bicycle having a chainwheel and a horizontal frame rod and a rear fasten plate and a rear wheel having a freewheel and a rear shaft, wherein a chain sleeved on the chainwheel and the freewheel allowing the rear wheel to be forwardly rotated for normally operating the chain and allowing the rear wheel to be stopped for reversely operating the chain thereby providing the bidirectional shifting, the bicycle derailleur including: a passive first derailleur installed on the fasten plate and the rear shaft of the bicycle, the passive first derailleur being able to be moveably inclined towards inward and the top and the bottom ends being respectively formed with an upper fasten part and a lower fasten part, the inner side defined at the top end of the upper fasten part being provided with a buckle plate having a buckle recess, the buckle plate being correspondingly installed on the rear fasten plate of the horizontal frame rod of the bicycle and the rear shaft having a nut served as a fasten member, the buckle plate being formed with a positioning hole, the positioning hole being sleeved and fastened on the fasten plate of the bicycle by utilizing a screw served as a fasten member, the lower fasten part being formed with a lower shaft hole, and the inner side thereof being downwardly and transversally extended with a moveable chain pulling arm, the top and the bottom ends of the chain pulling arm being respectively formed with upper guide teeth and lower guide teeth for allowing the chain of the bicycle to be normally operated for being guided onto the freewheel of the rear wheel, the upper guide teeth adjacent to the chain pulling arm being provided with a fasten shaft outwardly extended, the fasten shaft being corresponding to the lower shaft hole of the lower fasten part of the passive first derailleur, the fasten shaft being sleeved with a torsion spring allowing the chain pulling arm to be turned and folded; and characterized in that:
an active second derailleur being provided and the top end of the passive first derailleur being substantially in parallel with the active second derailleur; the active second derailleur being able to be movably inclined towards inward, and the bottom end defined at the inner side and the top end defined at the outer side being respectively provided with a pull string seat allowing a pull string to be abutted against and a fasten seat allowing the distal end of the pull string to be fastened, the top and the bottom ends of the active second derailleur being respectively formed with an upper fasten part and a lower fasten part, the upper fasten part of the active second derailleur being formed with an upper shaft hole and fastened on the rear shaft of the bicycle and located at the outer side of the buckle plate of the passive first derailleur, and a nut served as a fasten member being provided for fastening, the lower fasten part of the active second derailleur being formed with a lower shaft hole; the outer periphery of the torsion spring of the fasten shaft of the chain pulling arm of the passive first derailleur being sleeved with two corresponding inner springs; the lower shaft hole of the active second derailleur being provided a fasten member; the lower fasten part of the active second derailleur and the lower fasten part of the passive first derailleur and the horizontal frame rod of the bicycle being provided with a guide plate, the upper, the middle and the lower portions of the guide plate being respectively formed with an upper shaft, a fasten hole and an elongated slide groove, wherein the upper shaft being formed at top end defined in the upper portion of the guide plate and the outer side defined at the front end of the chain sleeved with the freewheel of the rear wheel of the bicycle for allowing the chain to be reversely operated for being guided onto the freewheel of the rear wheel, the fasten hole of the guide plate being corresponding to the inner side of the lower shaft hole of the lower fasten part of the active second derailleur, and being fastened by fasten member provided in the lower shaft hole, the elongated slide groove of the guide plate being sleeved at the center defined at the outer periphery of the torsion spring sleeved with the fasten shaft at the top end of the chain pulling arm of the passive first derailleur, and the two inner springs sleeved at the outer periphery of the torsion spring being clamped at two sides defined at the rear portion of the guide plate where the elongated slide groove being formed.

2. The bicycle derailleur as claimed in claim 1, wherein the bottom end of the upper shaft of the guide plate is further formed with a recess part which is vertically latched on the horizontal frame rod of the bicycle.

3. The bicycle derailleur as claimed in claim 1, wherein the upper shaft of the guide plate is provided with a rolling tube.

4. The bicycle derailleur as claimed in claim 1, wherein the fasten member provided in the lower shaft hole of the active second derailleur is a screw and a nut.

5. The bicycle derailleur as claimed in claim 3, wherein the bottom end of the upper shaft of the guide plate is further formed with a recess part which is vertically latched on the horizontal frame rod of the bicycle.

6. The bicycle derailleur as claimed in claim 4, wherein the bottom end of the upper shaft of the guide plate is further formed with a recess part which is vertically latched on the horizontal frame rod of the bicycle.

7. The bicycle derailleur as claimed in claim 2, wherein the upper shaft of the guide plate is provided with a rolling tube.

8. The bicycle derailleur as claimed in claim 4, wherein the upper shaft of the guide plate is provided with a rolling tube.

9. The bicycle derailleur as claimed in claim 2, wherein the fasten member provided in the lower shaft hole of the active second derailleur is a screw and a nut.

10. The bicycle derailleur as claimed in claim 3, wherein the fasten member provided in the lower shaft hole of the active second derailleur is a screw and a nut.
